(19) United States
(12) Patent Application Publication
(10) Pub. No.: US 2009/0295183 A1
(43) Pub. Date: Dec. 3, 2009

(54) ARTICULATING BINS

(76) Inventors: Mark G. Piekny, Bingham Farms, MI (US); Jeffrey Alan Binns, Monroe, MI (US); Tanya Sepell, Royal Oak, MI (US)

Correspondence Address: FRASER CLEMENS MARTIN & MILLER LLC, 28366 KENSINGTON LANE, PERRYSBURG, OH, 43551, US

(21) Appl. No.: 12/130,175

(22) Filed: May 30, 2008

(51) Int. Cl. B60R 7/06; B60N 3/00

(52) U.S. Cl. 296/37.1; 296/37.12; 224/282; 224/539

(57) ABSTRACT

A storage system and a method for controlling the deployment of the storage system, wherein the storage system provides additional storage space without the need for a second glove box door and latch. The storage system includes a first storage compartment defining a first storage cavity, a second storage compartment defining a second storage cavity, and an articulating armatures coupled to the second storage compartment, wherein the armature links the second storage compartment to a portion of the support structure for controlling the motion of the second storage compartment relative to the support structure.

### FIELD OF THE INVENTION

The present invention relates to storage compartments in vehicles. More particularly, the invention is directed to a storage system having a plurality of articulating storage compartments and a method for controlling the deployment and stowing of the storage system.

### BACKGROUND OF THE INVENTION

Automotive customers continue to request new innovative ideas for convenience and storage inside the automobiles of today. One outcome of this demand has been the emergence of the upper glove box housed in vehicle instrument Panels (IPs). This compartment typically consists of a hinged door and a shorter but deeper compartment than its lower glove box neighbor (both on the passenger side). The double door glove box system represents several challenges to auto manufacturers including: fit and finish, safety, design for manufacturability (DFM), ergonomics, cost and perceived functional quality.

Regarding fit and finish, the consistency of a gap between a glove box door and IP show surface is often difficult to control. Typically, variation of the gap is limited through a decrease in total stack componentry; e.g. a door hinged directly to pad, rather than surrounding; a door made small; or styling compromised to limit wavy line appearance.

Regarding safety, a glove box latch must not open upon head impact. Further, when a passenger air bag is activated, the glove box door must stay closed or, if in an open position, the glove box must be out of the way and carry no loose objects. Typical designs put limits on size, location, and stroke of latches. For example, a latch may be a push type but be very small so as to prevent head-form strike and inertial mass from opening door during impact; a latch may be of a pull type stroke; or a latch may be located outside head strike zone.

Regarding DFM, vehicles having more than one trim level often require a hard and soft IP version along an upper surface. Trimming out of a door in a soft version typically requires more components and/or more complex processes resulting in additional cost and tolerances than the hard trimmed version. More often than not, unique parts between levels are required, driving up costs.

Regarding ergonomics, glove box doors typically hinged along a top edge create a sight-line issue. Sight-line issues are addressed with more complex, large range of motion hinges and premium processing & tooling. As implied, more parts equate to a greater cost.

Regarding perceived functional quality, great attention to detail is given to this area of the instrument panel because of visibility. Money is spent at the expense of less visible areas to ensure clean execution of trim lines and dynamic function of mechanism (door).

It would be desirable to have a storage system and a method for controlling the deployment and stowing of the storage system, wherein the storage system provides additional storage space typically given by double door glove boxes without the need for the second glove box door and latch, thereby militating against the undesirable issues associated with double door glove boxes.

### SUMMARY OF THE INVENTION

Concordant and consistent with the present invention, a storage system and a method for controlling the deployment and stowing of the storage system, wherein the storage system provides additional storage space typically given by double door glove boxes without the need for the second glove box door and latch, thereby militating against the undesirable issues associated with double door glove boxes, has surprisingly been discovered.

In one embodiment, a storage system integrated with a support structure of a vehicle comprises a first storage compartment defining a first storage cavity, a second storage compartment defining a second storage cavity, and an articulating armatures coupled to the second storage compartment, wherein the armature links the second storage compartment to a portion of the support structure for controlling the motion of the second storage compartment relative to the support structure.

In another embodiment, a storage system comprises a first storage compartment defining a first storage cavity, a second storage compartment defining a second storage cavity, and an articulating armature coupled to the second storage compartment, wherein the articulating armature links the first storage compartment to the second storage compartment to control a movement of the second storage compartment in response to a movement of the first storage compartment.

The invention also provides methods for controlling the deployment and stowing of a storage system integrated with a support structure of a vehicle.

One method comprises the steps of: providing a first storage compartment defining a first storage cavity; providing a second storage compartment defining a second storage cavity; and linking the first storage compartment to the second storage compartment to control a movement of the second storage compartment in response to a movement of the first storage compartment.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a cross-sectional side view of a storage system according to an embodiment on the present invention showing the storage system closed.

FIG. 2 is a cross-sectional side view of the storage system of FIG. 1 showing the storage system opened.

FIG. 3 is a cross-sectional side view of a storage system according to another embodiment on the present invention showing the storage system closed.

FIG. 4 is a cross-sectional side view of the storage system of FIG. 3 showing the storage system opened.

FIG. 5 is a cross-sectional side view of a storage system according to another embodiment on the present invention showing the storage system closed.

FIG. 6 is a cross-sectional side view of the storage system of FIG. 5 showing the storage system partially opened.

FIG. 7 is a cross-sectional side view of the storage system of FIG. 5 showing the storage system completely opened.

FIG. 8 is a cross-sectional side view of a storage system according to another embodiment on the present invention showing the storage system closed.

FIG. 9 is a cross-sectional side view of the storage system of FIG. 8 showing the storage system opened.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

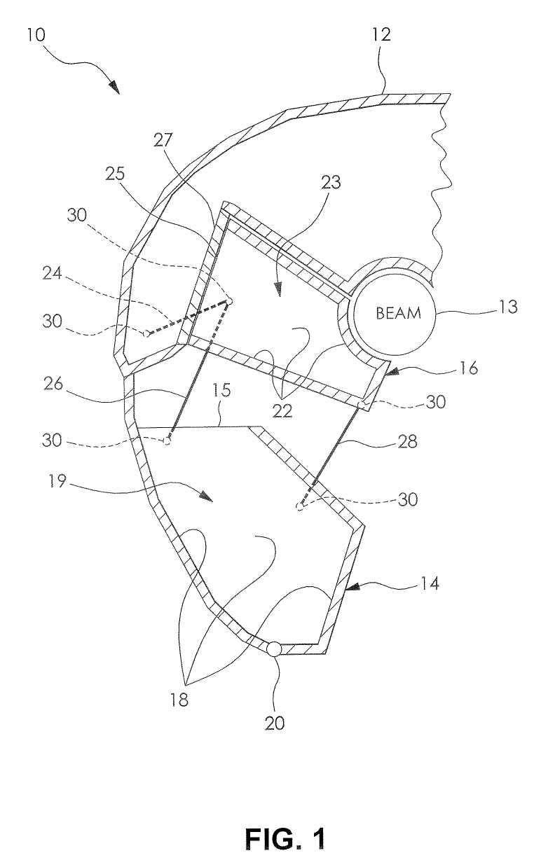

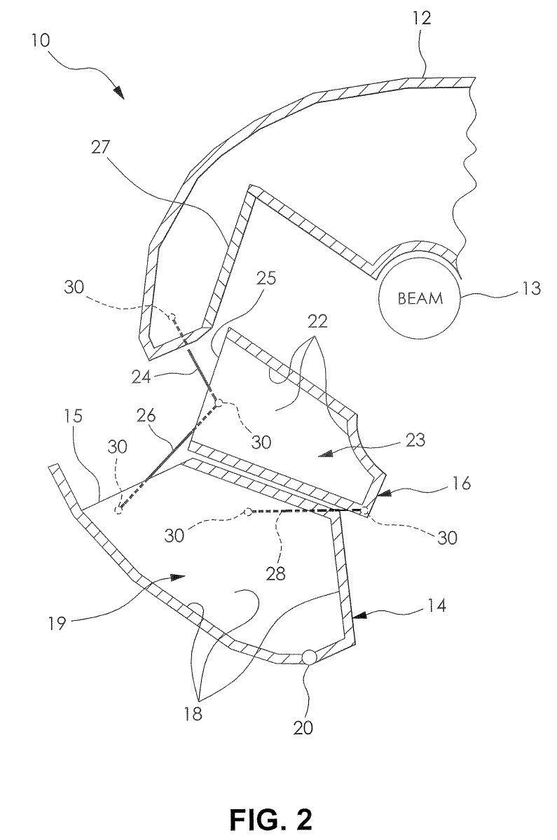

FIGS. 1 and 2 show a storage system 10 integrated with a support structure 12 of a vehicle according to an embodiment of the present invention. As a non-limiting example, the support structure 12 may be an instrument panel (IP) or a fixed structural element of the vehicle. It is understood that the storage system 10 may be adapted to integrate with support structures, instrument panels, and the like of various vehicles, as desired. It is further understood that the storage system 10 may be adapted to accommodate for structural elements of the vehicle such as a cross beam 13 and a passenger airbag system, for example.

The storage system 10 includes a first storage compartment 14 and a second storage compartment 16. It is understood that the storage system 10 may include additional features such as dampening devices and locking devices, as desired.

The first storage compartment 14 includes a plurality of interior surfaces 18 which define a first storage cavity 19. It is understood that the first storage compartment 14 may have any shape and size, as desired. It is further understood that each of the interior surfaces 18 may have any curvature or linear angle with respect to one another, as desired. An opening 15 formed in the first storage compartment 14 provides access to the first storage cavity 19. It is understood that the first storage compartment opening 15 may have any size and shape, as desired. The first storage compartment 14 is coupled to a portion of the support structure 12 of the vehicle by a hinge 20. It is understood that any number of hinges 20 may be used, as desired. It is further understood that other devices for coupling the first storage compartment 14 to the vehicle may be used, as appropriate. As shown, the first storage compartment 14 rotates about a linear axis through the center of the hinge 20. As shown in FIG. 1, the first storage compartment 14 is in a closed position or a stored position. As shown in FIG. 2, the first compartment is in an open position. It is understood that the rotational motion of the first storage compartment 14 may be dampened by a spring device (not shown). Other dampening devices for controlling the rotational motion of the first storage compartment 14 may be used, as desired. It is further understood that the first storage compartment 14 may have an engaging device (not shown) for engaging the support structure 12 of the vehicle and retaining the first storage compartment 14 in a stored position. As a non-limiting example, the engaging device may be a latch adapted to retain the first storage compartment 14 in closed position and selectively release and deploy the first storage compartment 14 into an open position. The first storage compartment 14 may also include a locking device (not shown) for securing the first storage compartment 14 in the stored position.

The second storage compartment 16 includes a plurality of interior surfaces 22 which define a second storage cavity 23. As shown, the second storage compartment 16 is adapted to accommodate the cross beam 13 of the vehicle. However, it is understood that the second storage compartment 16 may have any shape and size, as desired. Each of the interior surfaces 22 may have any curvature or linear angle with respect to one another, as desired. An opening 25 formed in the second storage compartment 16 provides access to the second storage cavity 23. As shown in FIG. 1, where the second storage compartment 16 is in a closed position or a stored position, an inner wall 27 of the support structure 12 covers the opening 25 to secure any contents of the second storage compartment 16. It is understood that the opening 25 can be closed by other components separately formed from the support structure 12, as desired.

The second storage compartment 16 is coupled to the first storage compartment 14 and the vehicle by a plurality of articulating armatures 24, 26, 28. The articulating armatures 24, 26, 28 are coupled to the first storage compartment 14, the second storage compartment 16, and a portion of the support structure 12 by a plurality of rotatable coupling devices 30. It is understood that any coupling device that secures the articulating armatures 24, 26, 28 to a desired surface while allowing rotation of the articulating armatures 24, 26, 28 along a desired plane may be used, as desired.

Specifically, at least one first articulating armature 24 is coupled to a portion of the support structure 12 and the second storage compartment 16. Any number of first articulating armatures 24 may be used, as desired. Where additional first articulating armatures 24 are used, each of the first articulating armatures 24 may be coupled to opposite surfaces of the second storage compartment 16 for stability and control. In the embodiment shown, the first articulating armature 24 is rigid and controls the motion of the second storage compartment 16 relative to the support structure 12.

At least one second articulating armature 26 is coupled to a portion of the second storage compartment 16 and a portion of the first storage compartment 14. Any number of second articulating armatures 26 may be used, as desired. Where additional second articulating armatures 26 are used, each of the second articulating armatures 26 may be coupled to opposite surfaces of the second storage compartment 16 for stability and control. In the embodiment shown, the second articulating armature 26 is rigid and controls the motion of the second storage compartment 16 in response to the motion of the first storage compartment 14. Further, as shown, the first articulating armature 24 and the second articulating armature 26 are coupled to the second storage compartment 16 at a common point.

At least one third articulating armature 28 is coupled to a portion of the second storage compartment 16 and a portion of the first storage compartment 14. Any number of third articulating armatures 28 may be used, as desired. Where additional third articulating armatures 28 are used, each of the third articulating armatures 28 may be coupled to opposite surfaces of the second storage compartment 16 for stability and control. In the embodiment shown, the third articulating armature 28 is rigid and controls the motion of the second storage compartment 16 in response to the motion of the first storage compartment 14. Further, as shown, the third articulating armature 28 is offset in a direction away from the opening direction of the first storage compartment 14 and spaced from the first and second articulating armatures 24, 26.

In use, the first storage compartment 14 rotates vehicle-rearward under its own weight in the traditional sense, causing the articulating armatures 24, 26, 28 to move and, in turn, causing the second storage compartment 16 to swing down and vehicle-forward, then down and vehicle-rearward. Specifically, the articulating armatures 24, 26, 28 guide the second storage compartment 16 along a pre-determined motion path. It is understood that the specific motion path of the second storage compartment 16 may be adapted for various vehicles and structural constraints. The loci or motion path of the second storage compartment 16 is constrained in such a way that the second storage compartment 16 is presented to a user upon opening and then seals against the interior wall 27 of the support structure 12 upon closing.

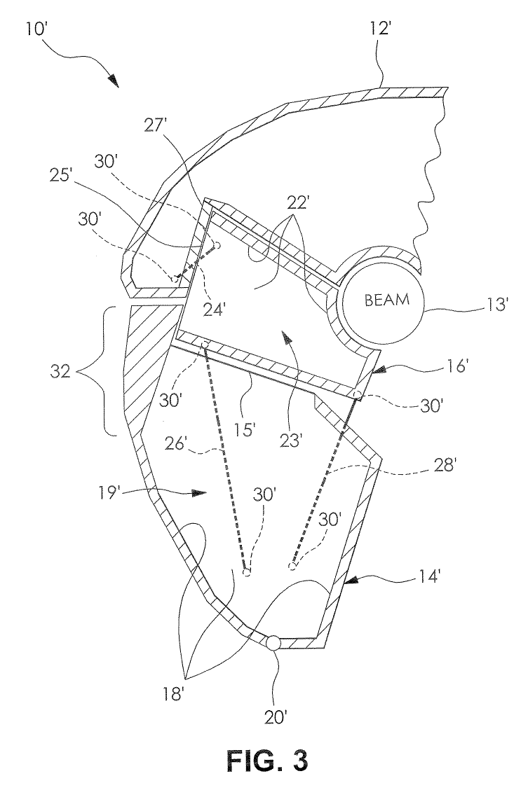

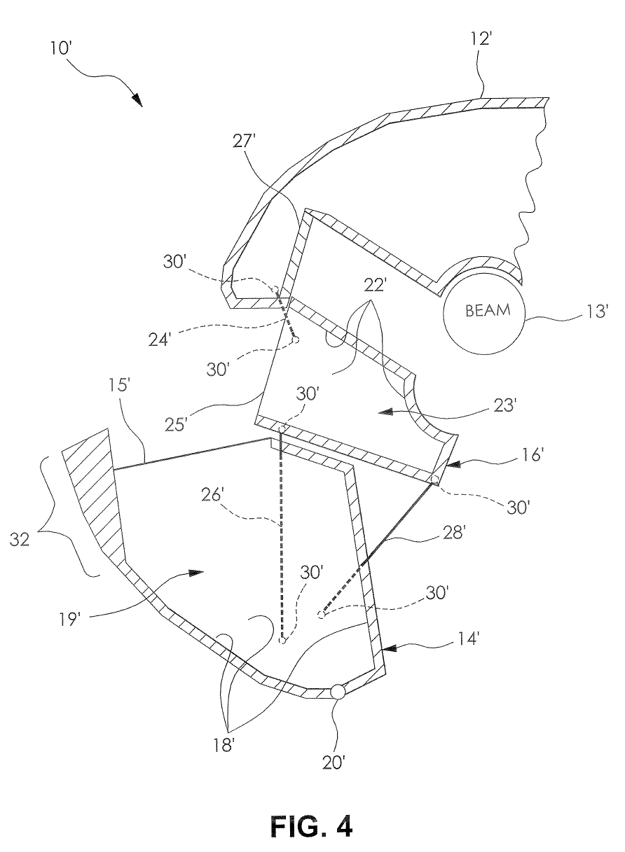

FIGS. 3 and 4 show a storage system 10′ integrated with a support structure 12′ of a vehicle according to another embodiment of the present invention similar to the storage system 10 of FIGS. 1 and 2, except as described below. Structure repeated from the description of FIGS. 1 and 2 includes the same reference numeral and a prime (′) symbol. As shown in FIG. 3, a first storage compartment 14′ is formed so that a first portion 32 of the first storage compartment 14′ is disposed adjacent at least a portion of a second storage compartment opening 25′ when the first storage compartment 14′ is in a closed or stored position. As shown, an interior wall 27′ of the support structure 12′ is adapted to cooperate with the first portion 32 of the first storage compartment 14′ to cover the opening 25′ and enclose a second storage cavity 23′, upon closing. It is understood that the position and length of a plurality of articulating armatures 24′, 26′, 28′ may be modified for controlling the motion of the second storage compartment 16′ during opening and closing.

In use, the first storage compartment 14′ rotates vehicle-rearward under its own weight, causing the articulating armatures 24′, 26′, 28′ to move, which in turn, causes the second storage compartment 16′ to swing down and vehicle-forward, then down and vehicle-rearward. Specifically, the articulating armatures 24′, 26′, 28′ guide the second storage compartment 16′ along a pre-determined motion path. The loci or motion path of the second storage compartment 16′ is constrained in such a way that the second storage compartment 16′ is presented to a user upon opening and then seals against the interior wall 27′ of the support structure 12′ and the first portion 32 of the first storage compartment 14′, upon closing.

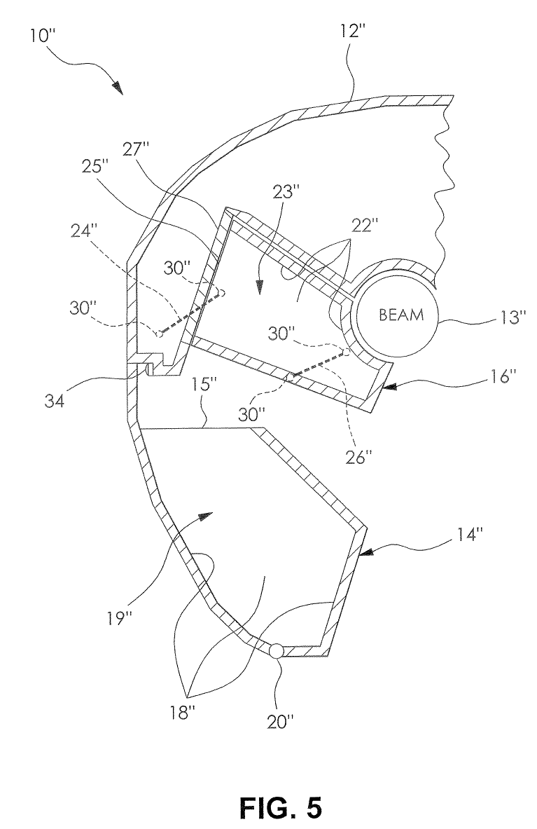

FIGS. 5, 6, and 7 show a storage system 10″ integrated with a support structure 12″ of a vehicle according to another embodiment of the present invention similar to the storage system 10 of FIGS. 1 and 2, except as described below. Structure repeated from the description of FIGS. 1 and 2 includes the same reference numeral and a double-prime (″) symbol for clarity. A second storage compartment 16″ includes a latch 34 adapted to retain the second storage compartment 16″ in a stored position and selectively release and deploy the second storage compartment 16″ to an open position. As shown, the second storage compartment latch 34 is a push button latch adapted to be selectively engaged and disengaged by the user. It is understood that other engaging devices for engaging the support structure 12″ and retaining the second compartment 16″ in a stored position may be used, as desired. It is further understood that the second storage compartment 16″ may include a locking device (not shown) for locking the second storage compartment 16″ in the stored position.

The second storage compartment 16″ is coupled to a portion of the support structure 12″ by at least one first articulating armature 24″. It is understood that any number of first articulating armatures 24″ may be used, as desired. Where additional first articulating armatures 24″ are used, each of the first articulating armatures 24″ may be coupled to opposite surfaces of the second storage compartment 16″ for stability and control. In the embodiment shown, the first articulating armature 24″ is rigid and controls the motion path of the second storage compartment 16″ relative to the support structure 12″. It is understood that the first articulating armatures 24″ may include additional features and devices such as a motion dampening device, for example.

The second storage compartment 16″ is also coupled to a static element (not shown) of the vehicle by at least one second articulating armature 26″. It is understood that any number of second articulating armatures 26″ may be used, as desired. Where additional second armatures are used, each of the second articulating armatures 26″ may be coupled to opposite surfaces of the second storage compartment 16″ for stability and control. In the embodiment shown, the second articulating armature 26″ is rigid and controls the motion path of the second storage compartment 16″ relative to the fixed environment of the vehicle. It is understood that the second articulating armatures 26″ may include additional features and devices such as a motion dampening device, for example.

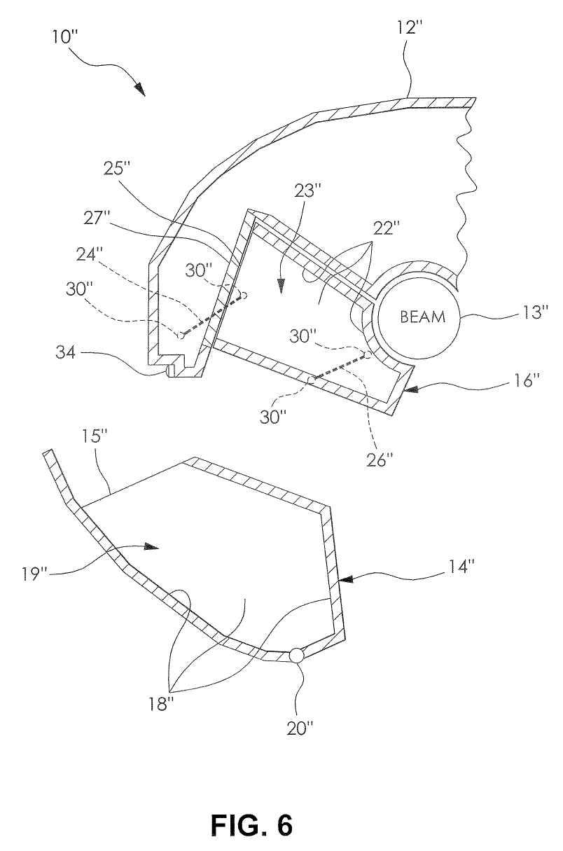

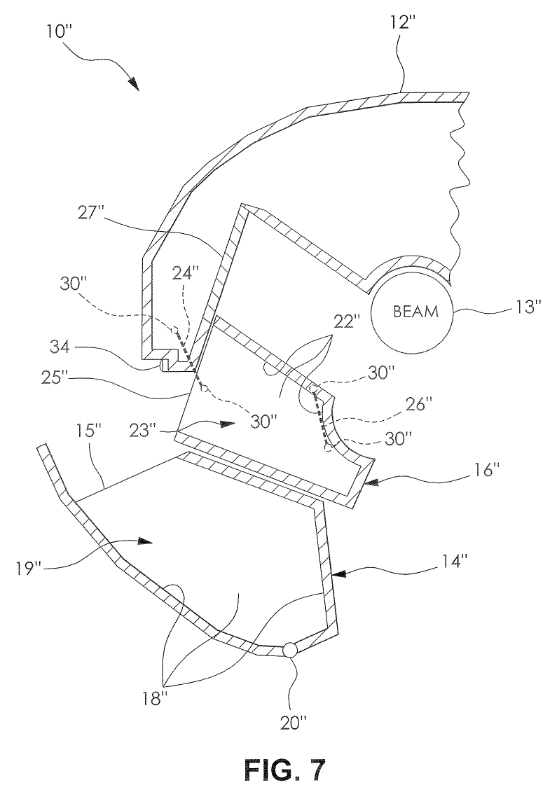

In use, a first storage compartment 14″ is deployed into an open position, shown in FIG. 6. After the first storage compartment 14″ is deployed, the second storage compartment 16″ remains secured in a stored position by the second storage compartment latch 34. As shown in FIG. 7, the second storage compartment latch 34 may be disengaged, thereby releasing and deploying the second storage compartment 16″ into an open position. Specifically, the first articulating armature 24″ and the second articulating armature 26″ guide the second storage compartment 16″ along a pre-determined motion path. It is understood that the weight of the second storage compartment 16″ including the weight of any contents will cause the second storage compartment 16″ to “fall” to the open position. It is further understood that dampening devices may be used to further control the motion of the second storage compartment 16″. During a closing operation or a stowing operation of the first storage compartment 14″, a portion of the first storage compartment 14″ contacts a portion of the second storage compartment 16″, thereby controlling the motion of the second storage compartment 16″ in response to the motion of the first storage compartment 14″. Other means of engaging the second storage compartment 16″ may be used such as additional armatures, for example. The first storage compartment 14″ is rotated into a closed position, thereby causing the second storage compartment 16″ to return to a closed position, shown in FIG. 5. It is understood that the second storage compartment 16″ may be secured in the storage position by the second storage compartment latch 34.

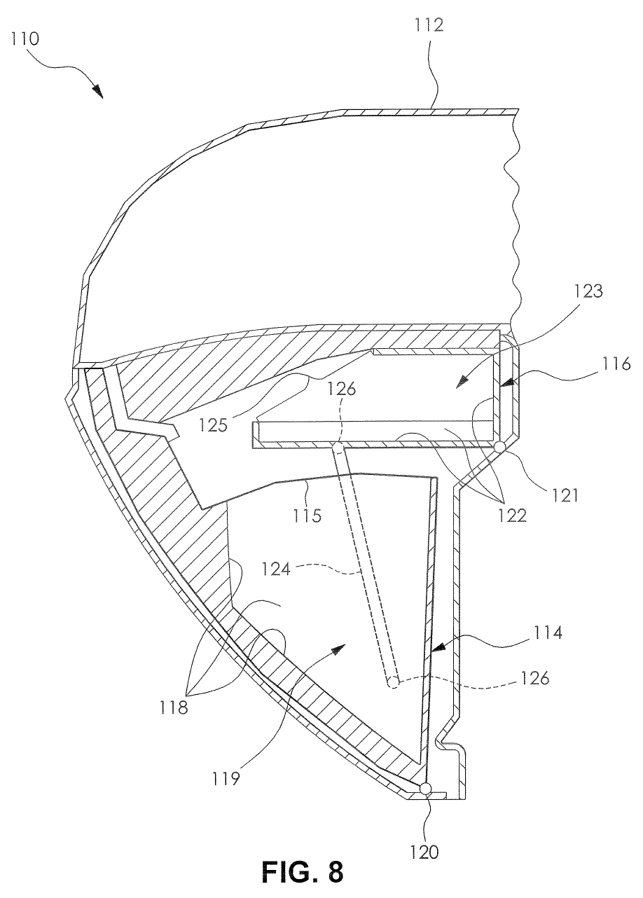

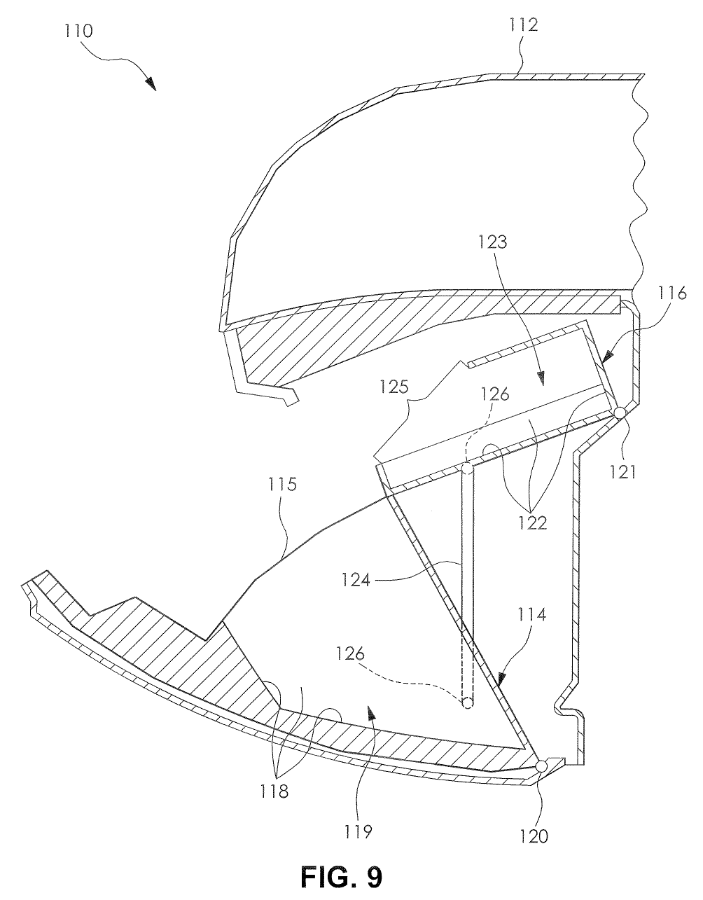

FIGS. 8 and 9 show a storage system 110 integrated with a support structure 112 of a vehicle according to another embodiment of the present invention. As a non-limiting example, the support structure 112 may be an instrument panel (IP) or a fixed structural element of the vehicle. It is understood that the storage system 110 may be adapted to integrate with support structures, instrument panels, and the like of various vehicles, as desired. It is further understood that the storage system 110 may be adapted to accommodate for structural elements of the vehicle such as a cross beam and a passenger airbag, for example.

The storage system 110 includes a first storage compartment 114 and a second storage compartment 116. The first storage compartment 114 includes a plurality of interior surfaces 118 which define a first storage cavity 119. It is understood that the first storage compartment 114 may have any shape and size, as desired. It is further understood that each of the interior surfaces 118 may have any curvature or linear angle with respect to one another, as desired. An opening 115 formed in the first storage compartment 114 provides access to the first storage cavity 119. It is understood that the first storage compartment opening 115 may have any size and shape, as desired. The first storage compartment 114 is coupled to a portion of the support structure 112 of the vehicle by a first hinge 120. The first storage compartment 114 may be attached to other fixed portions of the vehicle, as desired. It is understood that any number of hinges may be used, as desired. It is further understood that other devices for coupling the first storage compartment 114 to the vehicle may be used, as appropriate. As shown, the first storage compartment 114 rotates about a linear axis through the center of the first hinge 120. Further, the first storage compartment 114 may have an engaging device (not shown) for engaging the support structure 112 of the vehicle and retaining the first storage compartment 114 in a stored position. As a non-limiting example, the engaging device may be a latch adapted to retain the first storage compartment 114 in a closed position and selectively release and deploy the first storage compartment 114 into an open position. The first storage compartment 114 may also include a locking device (not shown) for securing the first storage compartment 114 in the stored position.

The second storage compartment 116 includes a plurality of interior surfaces 122 which define a second storage cavity 123. As shown, the second storage compartment 116 has been formed into a shelf. However, it is understood that the second storage compartment 116 may have any shape and size, as desired. Each of the interior surfaces 122 may have any curvature or linear angle with respect to one another, as desired. An opening 125 formed in the second storage compartment provides access to the second storage cavity 123. The second storage compartment 116 is coupled to a portion of the support structure 112 of the vehicle by a second hinge 121. The second storage compartment 116 may be attached to other fixed portions of the vehicle, as desired. It is understood that any number of hinges may be used, as desired. It is further understood that other devices for coupling the second storage compartment 116 to the vehicle may be used, as appropriate. As shown, the second storage compartment 116 rotates about a linear axis through the center of the second hinge 121.

As shown in FIG. 9, the second storage compartment 116 is adapted to abut a portion of the first storage compartment 114 in the open position in order to close off any space between the first storage compartment 114 and the second storage compartment 116, thereby militating against items falling behind the first storage compartment 114. It is understood that the storage system 110 may include additional features such as dampening devices and locking devices, as desired.

The second storage compartment 116 is coupled to the first storage compartment 114 by at least one articulating armature 124. It is understood that any number of articulating armatures 124 may be used, as desired. Where additional articulating armatures 124 are used, each articulating armature 124 may be coupled to opposite sides of the first storage compartment 114 and the second storage compartment 116 for stability and control. In the embodiment shown, the articulating armature 124 is coupled to the first storage compartment 114 and the second storage compartment 116 by a plurality of rotatable coupling devices 130. It is understood that any coupling device that secures the articulating armatures 124 to a desired surface while allowing rotation of the articulating armatures 124 along a desired plane may be used, as desired. If is further understood that the length and position on the articulating armatures 124 may be modified, as appropriate.

In use, the first storage compartment 114 rotates vehicle-rearward under its own weight in the traditional sense, thereby causing the second storage compartment 116 to pivot and provide access to the second storage cavity 123. Specifically, the motion of the first storage compartment 114 causes the coupled articulating arm 124 to move which, in turn, causes the second storage compartment 116 to pivot about the second hinge 121. It is understood that the specific motion path of the second storage compartment 116 may be adapted for various vehicles and structural constraints. The loci or motion path of the second storage compartment 116 is constrained in such a way that the second storage compartment 116 is presented to a user upon opening.

The storage system 10, 10′, 10″, 110 provides additional storage space using available space behind a vehicle support structure 12, 12′, 12″, 112 while eliminating the need for a second glove box door. Additionally, the storage system 10, 10′, 10″, 110 and the method for deployment and stowing the storage system storage system 10, 10′, 10″, 110 provide a cleanly executed upper IP surface and a cost efficient alternative to double door glove boxes.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. A storage system integrated with a support structure of a vehicle, the storage system comprising;
a first storage compartment defining a first storage cavity;
a second storage compartment defining a second storage cavity; and
a plurality of articulating armatures coupled to the second storage compartment, wherein at least one armature links the second storage compartment to a portion of the support structure for controlling the motion of the second storage compartment relative to the support structure.

2. The storage system according to claim 1, wherein the first storage compartment includes a first opening for providing access to the first storage cavity.

3. The storage system according to claim 1, wherein the second storage compartment includes a second opening for providing access to the second storage cavity.

4. The storage system according to claim 1, wherein the first storage compartment includes an engaging means for securing the first storage compartment in a stored position.

5. The storage system according to claim 1, wherein the second storage compartment includes a latch adapted to retain the second storage compartment in a stored position and selectively release and deploy the second storage compartment into an open position.

6. The storage system according to claim 1, wherein the articulating armature is coupled to the second storage compartment by rotatable coupling devices.

7. A storage system comprising;
a first storage compartment defining a first storage cavity;
a second storage compartment defining a second storage cavity; and
an articulating armature coupled to the second storage compartment, wherein the articulating armature links the first storage compartment to the second storage compartment to control a movement of the second storage compartment in response to a movement of the first storage compartment.

8. The storage system according to claim 7, wherein the first storage compartment, the second storage compartment, and the articulating armature are integrated with a support structure of a vehicle.

9. The storage system according to claim 7, wherein the first storage compartment includes a first opening for providing access to the first storage cavity.

10. The storage system according to claim 7, wherein the second storage compartment includes a second opening for providing access to the second storage cavity.

11. The storage system according to claim 8, wherein at least one articulating armature links the second storage compartment to a portion of the support structure.

12. The storage system according to claim 8, wherein the support structure includes an interior wall adapted to enclose the second storage cavity while the second storage compartment is in a closed position.

13. The storage system according to claim 8, wherein the first storage compartment is hingedly attached to a portion of the support structure.

14. The storage system according to claim 8, wherein the second storage compartment is a shelf and is pivotally attached to a portion of the support structure.

15. The storage system according to claim 7, wherein the first storage compartment includes an engaging means for securing the first storage compartment in a stored position.

16. The storage system according to claim 7, wherein the articulating armatures are coupled to the first storage compartment and the second storage compartment by rotatable coupling devices.

17. A method for controlling the deployment and stowing of a storage system integrated with a support structure of a vehicle, the method comprising the steps of:
providing a first storage compartment defining a first storage cavity;
providing a second storage compartment defining a second storage cavity; and
linking the first storage compartment to the second storage compartment to control a movement of the second storage compartment in response to a movement of the first storage compartment.

18. The method according to claim 17, wherein the first storage compartment is hingedly attached to a portion of the support structure of the vehicle.

19. The method according to claim 17, wherein the second storage compartment is a shelf pivotally attached to a portion of the support structure of the vehicle.

20. The method according to claim 17, wherein the second storage compartment is linked to the first storage compartment by a plurality of articulating armatures for controlling the movement of the second storage compartment in response to the movement of the first storage compartment.
